(19) United States
(12) Patent Application Publication
(10) Pub. No.: US 2025/0211657 A1
(43) Pub. Date: Jun. 26, 2025

(54) KEY-VALUE-BASED QUEUE PAIR INTERFACE AND DATA EXCHANGE

(71) Applicant: The Regents of the University of California, Oakland, CA (US)

(72) Inventor: Xiaoyi Lu, Merced, CA (US)

(21) Appl. No.: 18/987,982

(22) Filed: Dec. 19, 2024

Related U.S. Application Data
(60) Provisional application No. 63/612,929, filed on Dec. 20, 2023.

(51) Int. Cl. H04L 69/22; H04L 49/9005

(52) U.S. Cl. CPC H04L 69/22; H04L 49/9005

(57) ABSTRACT

In some implementations, a method includes (a) transferring a communication engine of a key-value system (KVS) from a server central processing unit (CPU) to a data processing unit (DPU); (b) receiving, at the DPU, a network packet comprising a key-value request; (c) parsing, at the DPU, the network packet to extract the key-value request; (d) transmitting the key-value request from the DPU to the CPU; (e) processing, at the CPU, the key-value request to generate a response; and (f) transmitting the response from the CPU to the DPU. Related apparatus, systems, techniques, and articles are also described.

### CROSS-REFERENCE TO RELATED APPLICATIONS

This application claims the benefit of U.S. Provisional Patent Application No. 63/612,929, filed Dec. 20, 2023, and entitled “Key-Value-Based Queue Pair Interface and Data Exchange,” the contents of which are hereby fully incorporated by reference.

### TECHNICAL FIELD

The subject matter described herein relates to key-value-based queue pair interface and data exchange.

### BACKGROUND

Data processing units (DPUs) as advanced smart network interface cards (SmartNICs), are increasingly popular in data centers due to their ability to help servers offload tasks to save precious server CPU cycles. In-memory key-value stores (KVS) are primarily used for many data-intensive systems and applications like cloud services in data centers. How to efficiently exchange data between CPU and DPU is being explored. State-of-the-art solutions include gRPC Remote Procedure Calls (gRPC), dynamic memory access (DMA), or message passing interface (MPI). But they are either too heavy (in the case of gRPC or MPI) or only provide buffer-based data exchange methods (in the case of DMA), which do not interoperate well with many data center applications' requirements for key-value semantics. Hence, efficiently exploiting DPUs for in-memory CPU-based KVS without modifying their semantics, consistency model, underlying key-value data structures, and memory management schemes is challenging.

### SUMMARY

Disclosed is a system, apparatus, and method for key-value-based queue-pair interface and data exchange. In some example embodiments, there may be provided articles of manufacture for implementing the key-value-based queue-pair interface and data exchange as substantially described and shown herein.

In some embodiments, there is provided a system including at least one data processor and at least one memory storing instructions which, when executed by the at least one data processor, cause operations including (a) transferring a communication engine of a key-value system (KVS) from a server central processing unit (CPU) to a data processing unit (DPU); (b) receiving, at the DPU, a network packet comprising a key-value request; (c) parsing, at the DPU, the network packet to extract the key-value request; (d) transmitting the key-value request from the DPU to the CPU; (e) processing, at the CPU, the key-value request to generate a response; and (f) transmitting the response from the CPU to the DPU.

In some variations, one or more features disclosed herein including one or more of the following features may be implemented as well. Transmitting the key-value request uses a request queue pair shared by the CPU and DPU. Transmitting the key-value response uses a response queue pair shared by the CPU and DPU. The DPU comprises a plurality of DPU cores, wherein the CPU comprises a plurality of CPU cores. The communication engine transferred to the DPU is removed from the CPU. A core of the plurality of cores of the DPU is mapped to at most one core of the plurality of cores of the CPU. A core of the plurality of cores of the CPU is mapped to at most one core of the plurality of cores of the DPU. The core of the plurality of cores of the CPU is mapped to at least two cores of the plurality of cores of the DPU.

Additionally, in an aspect, a system can comprise a server central processing unit (CPU), a data processing unit (DPU) and a key-value system (KVS). The DPU can be configured to receive, from the server CPU, a communication engine of the KVS. The DPU can be configured to receive a network packet comprising a key-value request, transmit the key-value request to the server CPU, and receive a response from the server CPU. The server CPU can be configured to transmit the communication engine of the KVS to the DPU, receive the key-value request from the DPU, process the key-value request to generate the response, and transmit the response to the DPU.

One or more of the following features can be included in any feasible combination. For example, transmitting the key-value request can use a request queue pair shared by the CPU and DPU. Transmitting the key-value response can use a response queue pair shared by the CPU and DPU. The DPU can comprise a plurality of DPU cores and the CPU can comprise a plurality of CPU cores. The communication engine transferred to the DPU can be removed from the CPU. A core of the plurality of DPU cores can be mapped to at most one core of the plurality of CPU cores. A core of the plurality of CPU cores can be mapped to at most one core of the plurality of DPU cores. A core of a plurality of CPU cores can be mapped to at least two cores of the plurality of DPU cores. A core of a plurality of DPU cores can be mapped to at least two cores of the plurality of CPU cores. The communication engine transferred the DPU is not removed from the CPU and the communication engine transferred to the DPU is a first communication engine and the communication engine not removed from the CPU is a second communication engine.

The communication engine can comprise a set of data plane libraries and network interface controller (NIC) drivers. The communication engine can further comprise a function for extracting a key-value request from a network packet, a response function for allocating and preparing a networking buffer where populating the network buffer with a packet comprises a response to the key-value request and providing the packet to a client device, and an application programming interface (API) for receiving a network packet from a receive queue.

A communication engine of a key-value system (KVS) can be transferred from a server CPU to a DPU. The DPU can receive a network packet comprising a key-value request. The DPU can parse the network packet to extract the key-value request. The key-value request can be transmitted from the DPU to the CPU. The CPU can process the key-value request to generate a response. The response can be transmitted from the CPU to the DPU.

The details of one or more variations of the subject matter described herein are set forth in the accompanying drawings and the description below. Other features and advantages of the subject matter described herein will be apparent from the description and drawings, and from the claims.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is an exemplary key-value data exchange between a host CPU and a DPU.

FIG. 2 is a system diagram illustrating an example system that can transfer a communication engine of a key-value system (KVS) between a server central processing unit (CPU) and a data processing unit (DPU).

FIG. 3 is a data flow diagram illustrating an example data communication flow for key-value data exchange between a host CPU and a DPU.

Like reference symbols in the various drawings indicate like elements.

### DETAILED DESCRIPTION

Disclosed is a system, apparatus, and method for key-value-based queue-pair interface and data exchange. The disclosure includes information about data, file formats, and/or protocols for implementing the method. The method disclosed herein may be implemented as, for example, a shim layer on top of NVIDIA®'s data processing unit (DPU) software development kit (SDK) (DOCA™) dynamic memory access (DMA) subsystem with Bluefield®'s DPU hardware. The memory subsystem can also include memory-store with intelligent concurrent access (“MICA”). MICA can server as a highly optimized memory key-value store system The method may be generalized to many different types of DPU solutions. The disclosed method may provide an approach for implementing DPUs in data centers that is 1) easier to program with DPU for applications, 2) reduces peripheral component interconnect express (PCIe) bus traffic for workloads, and 3) provides better efficiency and scalability.

The disclosed queue pair-based programming interface comprises a send or request queue and receive or response queue on each of a host central processing unit (CPU) and a data processing unit (DPU) for exchanging data between them. In other words, the CPU and DPU can each have a request queue which forms a request queue-pair. Hence, there exist two request queues between the DPU and CPU. The CPU and the DPU also each have a response queue which form as a response queue-pair. Hence, there exists two response queues. Thus, there is one queue for sending and receiving requests (“request queue-pair”). The other queue is for sending and receiving responses (“response queue-pair”). Current queueing-based programming interfaces only offer buffer-based application programming interfaces (APIs), but the disclosed interface extends them to support key-value semantics.

A central processing unit (CPU) described herein may refer to a computer processor comprising electronic circuitry configured to execute instructions of a computer program, such as arithmetic, logic, controlling, and input/output (I/O) operations.

A data processing unit (DPU) described herein may refer to a programmable computer processor that may integrate a CPU with network interface hardware. Herein, the term DPU may be interchangeable with the term “smart network interface card (SmartNIC).” DPUs can be used in place of traditional NICs to relieve the main CPU of complex networking responsibilities and other “infrastructural” duties. For example, a data processing unit may perform encryption/decryption, serve as a firewall, or function as a hypervisor or storage controller.

A graphics processing unit (GPU) described herein may refer to a specialized electronic circuit that can accelerate computing tasks which may be memory-intensive and/or require accelerated arithmetic calculations. Non-limiting examples of these tasks include image processing and training machine learning algorithms.

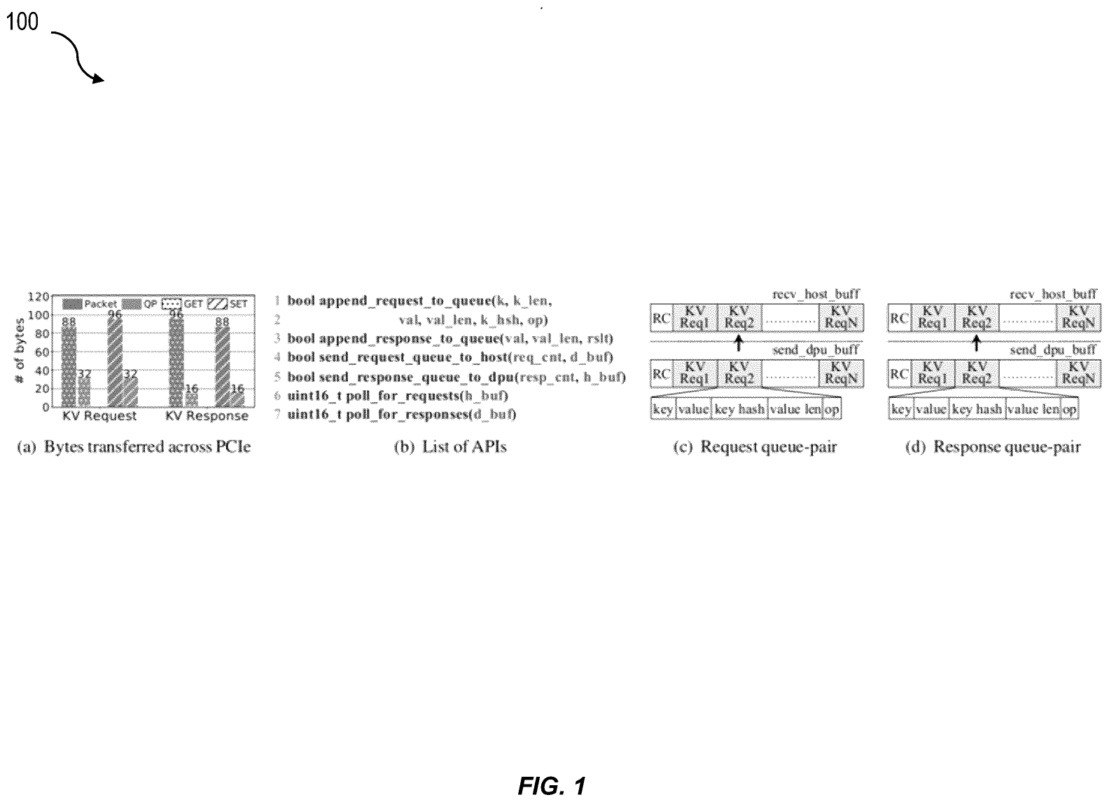

FIG. 1 illustrates an exemplary key-value data exchange between a host CPU and a DPU, in accordance with some embodiments. 1(a) illustrates example bytes transferred across PCIe for conventional CPU-only KVS vs. a queue-pair programming model. 1(b) illustrates an example list of APIs. 1(c) and 1(d) illustrate example key-value data exchange between a host and DPU. RC (one byte only) denotes the total request/response count in the buffer. In one embodiment, the space sizes of key-value requests (32 bytes) and responses (16 bytes) are fixed. In another embodiment, the key length is always 8 bytes. The request-queue pairs comprise an integer number N key-value pairs. After parsing the key-value request by the DPU, append_request_to_queue adds relevant fields, such as type of operation (e.g., GET or SET), key and its hash, and value to the send queue of the DPU. A GET operation can retrieve a key-value pair in memory while a SET operation can store a key-value pair in memory. Once all received requests have been parsed and added to the DPU's send queue, send_request_queue_to_host transfers the DPU buffer to the host buffer for processing. The CPU uses poll_for_requests API on its receive queue to wait for requests. Once the host receives the parsed requests from the DPU, it processes them and adds the result for the key-value request via append_response_to_queue and subsequently transfers the responses to the DPU using send_response_queue_to_dpu. The DPU, after sending the requests to the host, waits for responses by polling on its receive queue through poll_for_responses API and prepares the response packet, which can be sent back to the client.

Although the embodiment of FIG. 1 is illustrated and described with fixed-length key value pairs, FIG. 1 and its accompanying description should not be construed to be limiting, as the length of an individual key value pair can differ from the lengths of other key pairs in a request and/or response. In longer-length key-value pairs, the extra byte length can be used to track an offset or a beginning and/or ending of each key value pair in a packet.

The disclosed method may offload a communication engine (e.g., Data Plane Development Kit (DPDK)) to the advanced reduced instruction set computer (RISC) machine (ARM) cores of the DPU. Although described with offloading communication engines, other engines, such as processing engines, indexing engines, lookup engines, GET and PUT operations, and/or the like can also be offloaded to the DPU. For example, one method to offload GET operations on the DPU, key value pairs from the CPU memory can be stored or cached in the DPU memory. If the key value pair is located in the stored cache of the DPU, then the DPU can directly return the value to the client for the GET operation. If the key value pair is not located in the stored cache of the DPU, the DPU can automatically obtain another copy of the key value pairs from the CPU memory without any involvement from the CPU. Once the key value pair is located by the DPU, the corresponding key value pair may be provided back to the client.

In another example, when the CPU or DPU receives a PUT request from a client, this request may be offloaded to the DPU for processing. When the DPU receives the PUT request from either the CPU or the client, the DPU may first store the PUT request in a cached copy of key value pairs on the DPU memory. The DPU may then synchronize it back to the CPU memory synchronously or asynchronously. The response may be automatically generated by the DPU and sent back to the client.

A core of the plurality of cores of the CPU may be mapped to any number of the plurality of cores of the DPU. Additionally, a core of the plurality of cores of the DPU may be mapped to any number of the plurality of cores of the CPU. In some implementations, a core of the plurality of CPU cores can be mapped to at most one core of the plurality of cores of the DPU or mapped to at least two cores of the plurality of DPU cores. In some implementations, a core of the plurality of DPU cores can be mapped to at most one core of the plurality of cores of the CPU or mapped to at least two cores of the plurality of CPU cores. This can help improve overall system latency and reduce system complexity as the cores maintains its own communication and synchronization between the DPU and CPU.

The preceding examples should not be construed to limiting as those of ordinary skill in the art will understand that other similar operations to offload operations to the DPU may be possible.

In any of the preceding examples, the engine will not forward raw network packets to the CPU directly since the packets may have redundant information. Apart from the key-value request, a raw network packet also contains layer-2, layer-3, and layer-4 headers. The method disclosed herein parses the network packet and extracts the key-value information from it. Only relevant fields for key-value processing may be stored and sent to the CPU. Other key-value fields, such as request timestamp and request descriptor, are stored on the CPU to prepare the response packet. Keeping the direct memory access (DMA) buffer size to a minimum may help reduce unnecessary peripheral component interconnect express (PCIe) traffic, improving efficiency and scalability for applications.

The server CPU polls on the first byte of the recv_host_buffer that holds the count of the total number of requests that need to be processed. For a GET operation, after processing a request, the server may store the result and/or the value and value_length in the send_host_buffer of the response queue-pair. For a PUT operation, after processing a request, the server may store the result or response (i.e. the success or failure) in the send_host_buffer of the response queue-pair. Then, using send_response_queue_to_dpu_API, the server performs a DMA write to send the responses to the recv_dpu_buffer of the response queue-pair. The DPU waits for key-value responses from the server and prepares a response network packet to be sent back to the client. Each server core and DPU core maintain their own request and response queue-pairs to avoid inter-core communication overheads.

Below is a list of system APIs and functions:
bool append_request_to_queue (key, key_len, value, value_len, key_hash, operation)—After parsing the key-value request by the DPU, this append_request_to_queue API adds the relevant fields like the type of operations (GET/SET/others), key and its hash, and value to the send queue of the DPU.
bool send_request_queue_to_host (request_cnt, dpu_buf)—Once all received requests have been parsed and added to the DPU's send queue, this send_request_queue_to_host API transfers the DPU buffer to the host buffer for processing.
uint16_t poll_for_requests (host_buf)—The host uses this poll_for_requests API on its receive queue to wait for requests.
bool append_response_to_queue (value, value_len, result)—Once the host receives the parsed requests from the DPU, the host processes it and adds the result for the key-value request via this append_response_to_queue API.
bool send_response_queue_to_dpu (response_cnt, host_buf)—The host subsequently transfers the responses to the DPU using this send_response_queue_to_dpu API.
uint16_t poll_for_responses (dpu_buf)—The DPU after sending the requests to the host, waits for responses by polling on its receive queue through this poll_for_responses API and prepares the response packet which can be sent back to the client.

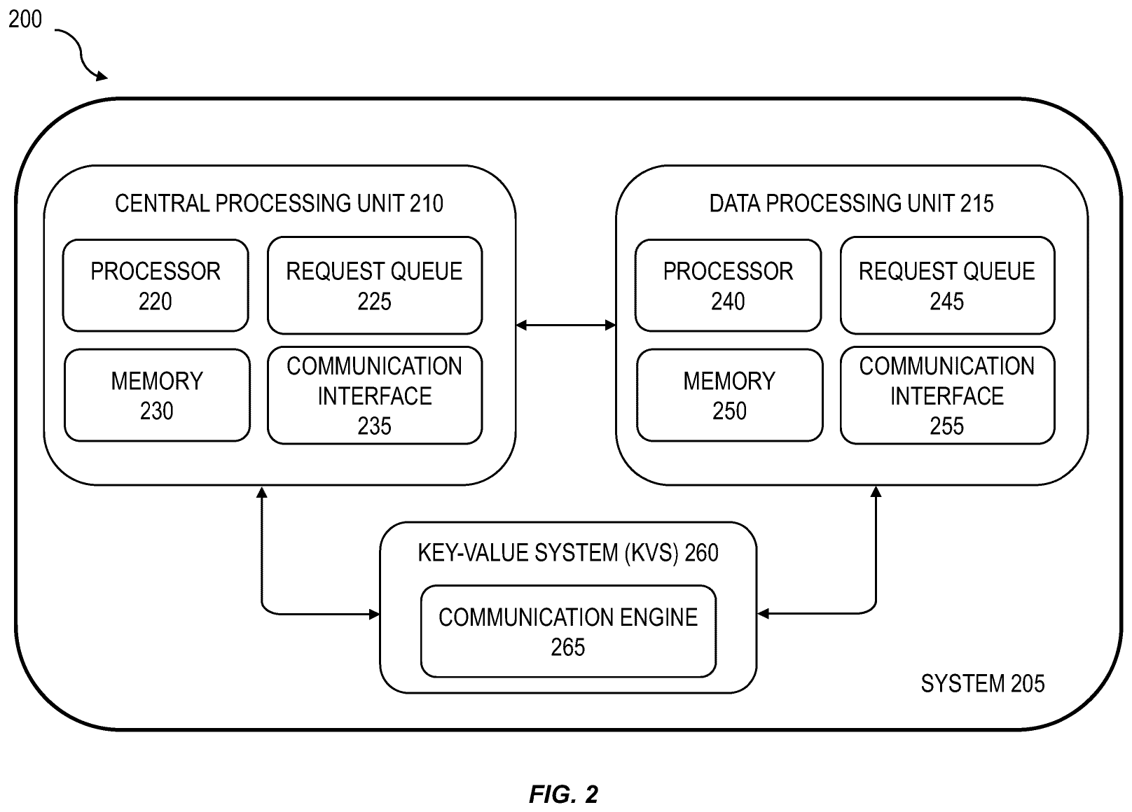

FIG. 2 is a system diagram illustrating an example system that can transfer a communication engine of a key-value system (KVS) between a server central processing unit (CPU) and a data processing unit (DPU). For example, system 205 can include a central processing unit 210, a data processing unit 215, and a key-value system (KVS) 260.

The central processing unit 210 can include at least a processor 220, a request queue 225, a memory 230, and a communication interface 235. In some embodiments, the processor 220 can include a plurality of processor cores. In some embodiments, the processor 220 can performs key-value related operations like indexing, maintaining key-value data structures, and storing/retrieving a (key, value) pair in/from memory. In some embodiments, the central processing unit 210 can send and receive data from the data processing unit 215. For example, the request queue 225 can send and receive data using queues between the central processing unit 210 and the data processing unit 215. In some embodiments, the request queue 225 includes a request queue and a response queue for exchanging data. In some embodiments, the communication interface 235 can facilitate the exchange of data between the central processing unit 210 and the data processing unit 215. For example, key-value data exchange can occur between the central processing unit 210 and the data processing unit 215, including an exchange of key-value pairs, request for key-values, requests for data, network information, or other forms of data. In some embodiments, the central processing unit 210 can transfer a communication engine of the key-value system to the data processing unit 215. In some embodiments, key-value pairs can be stored in the memory 230. The memory 230 can include a cache, memory storage, or other forms of memory.

The data processing unit 215 can include at least a processor 240, a request queue 245, a memory 250, and a communication interface 255. In some embodiments, the processor 240 can include a plurality of processor cores. In some embodiments, the processor 240 can performs key-value related operations like indexing, maintaining key-value data structures, and storing/retrieving a (key, value) pair in/from memory. In some embodiments, the data processing unit 215 can send and receive data from the central processing unit 210. For example, in some embodiments, the request queue 245 can send and receive data using queues between the central processing unit 210 and the data processing unit 215. In some embodiments, the request queue 245 includes a request queue and a response queue for exchanging data. In some embodiments, the communication interface 255 can facilitate the exchange of data between the central processing unit 210 and the data processing unit 215. For example, key-value data exchange can occur between the central processing unit 210 and the data processing unit 215, including an exchange of key-value pairs, request for key-values, requests for data, network information, or other forms of data. In some embodiments, the data processing unit 215 can transfer a communication engine of the key-value system to the central processing unit 210. In some embodiments, key-value pairs can be stored in the memory 250. The memory 250 can include a cache, memory storage, or other forms of memory.

The key-value system 260 can include a communication engine 265. In some embodiments, the communication engine 265 can be transferred between the central processing unit 210 and the data processing unit 215. In some embodiments, the communication engine 265 can originate in the central processing unit 210 or the data processing unit 215 before the transfer.

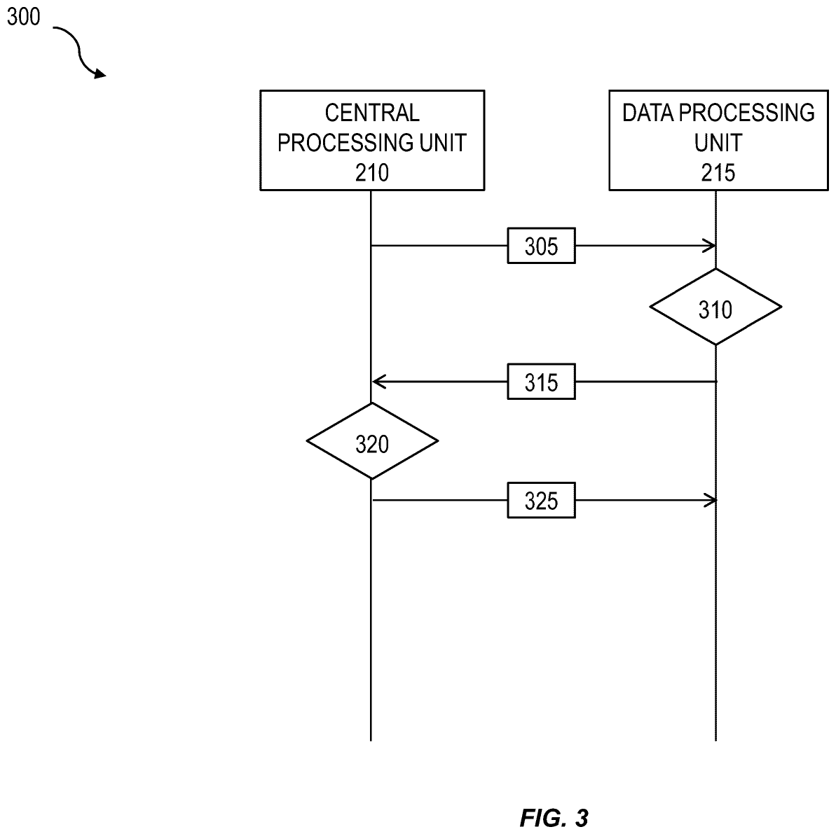

FIG. 3 is a data flow diagram illustrating an example data communication flow for key-value data exchange between a host CPU and a DPU. At 305, a communication engine of a key-value system (KVS) can be transferred from a central processing unit 210 to a data processing unit 215. In some embodiments, the communication engine includes a set of data plane libraries and network interface controller (NIC) drivers. In some embodiments, the communication engine can further include a function for extracting a key-value request from a network packet, a response function for allocating and preparing a networking buffer where populating the network buffer with a packet comprises a response to the key-value request and providing the packet to a client device, and an application programming interface (API) for receiving a network packet from a receive queue.

At 310, the data processing unit 215 can parse the network packet to extract the key-value request. For example, the data processing unit 215 can parse the network packet to identify relevant fields and headers for key-value processing. In some embodiments, the data processing unit 215 can extract relevant fields from the network packet, such as request timestamp and request descriptor, and store this information in memory 250, such as a send queue, buffer, or stored cache, as part of the key-value request. In some embodiments, after the data processing unit 215 parses the key-value request, the data processing unit can perform additional operations, such as GET and PUT operations, and generate additional relevant fields. These additional relevant fields can be added to memory 250, such as type of type of operation (e.g., GET or SET), key and its hash, and value. In some embodiments, the additional relevant fields can be added using an API, such as append_request_to_queue. The data processing unit 215 can assemble the data stored in the send queue into the key-value request.

At 315, the key-value request can be transmitted from the data processing unit 215 to the central processing unit 210. In some embodiments, the data processing unit 215 can send the data from its send queue to the central processing unit 210, including the key-value request. In some embodiments, the central processing unit 210 includes a receive queue and can poll the receive queue while waiting for incoming key-value requests. After the data processing unit 215 sends the key-value request, the unit can wait for responses from the central processing unit 210 by polling its receive queue. The data processing unit 215 can also prepare a response packet in preparation of receiving a response from the central processing unit 210. In some embodiments, the central processing unit 210 and the data processing unit 215 polling can be completed using an API, such as poll_for_responses. In some embodiments, the key-value request can be transmitted using a request queue pair shared by the central processing unit 210 and the data processing unit 215. The request queue pair can include a send or request queue and receive or response queue on each of a central processing unit 210 and a data processing unit 215 for exchanging data between them.

In some embodiments, the data processing unit 215 can process multiple network packets to extract multiple key-value requests. For example, the data processing unit 215 can receive a batch of network packets and extract multiple key-value requests. Rather than transmitting each request individually, the data processing unit 215 can parse all the requests in the batch and send them together as a single request.

At 320, the central processing unit 210 can process the key-value request to generate a response. In some embodiments, the central processing unit 210 can process the key-value request differently depending on the key-value request received from the data processing unit 215. For example, for a GET operation, after processing a request, the central processing unit 210 may store the result and/or the value and value_length in the send_host_buffer of the response queue-pair. For a PUT operation, after processing a request, the central processing unit 210 may store the result or response (i.e. the success or failure) in the send_host_buffer of the response queue-pair. In some embodiments, the central processing unit 210 can add additional key-value fields, such as the request timestamp and request descriptor, in generating the response. In some embodiments, the key-value response can be transmitted using a request queue pair. In some embodiments, multiple key-value requests can be stored in the data processing unit 215 and multiple key-value responses can be stored in the central processing unit 210 in the order they were received. At 325, the response can be transmitted from the CPU to the DPU.

In some embodiments, steps 305-325 can occur concurrently. For example, while the central processing unit 210 is preparing the response from a received key-value request, the data processing unit 215 can allocate network buffers for new requests, free buffers which have been processed, fill the next response packet with other data related to key-value items like key hash, request timestamp and packet-related information like source/destination addresses, packet length, and network protocol type. Additionally, the data processing unit 215 can process the next incoming network packet to extract the key-value request. Overlapping steps 305-325 between the central processing unit 210 and the data processing unit 215 can increase operational efficiency by reducing the overall request processing time.

The disclosed method may be used for many applications, including for key-value stores, not only structured query language (NoSQL) stores, databases, and/or other applications. In addition to DPUs, the disclosed method may apply to other PCIe devices such as GPUs, computational solid state drives (SSDs), and other similar PCIe devices.

The subject matter described herein provides many technical advantages. For example, by exchanging data between the CPU and DPU, tasks can be efficiency scheduled between each processing unit, which optimizes the system performance. Further, by offloading tasks to the DPU, the CPU can be freed to focus on other computational-intensive processes, which can improve resource utilization and computational performance. This can also allow the CPU and DPU to run simultaneously, increasing throughput and reducing execution and latency times. Additionally, while typical systems can experience a vast amount of network traffic and bandwidth restrictions due to bus limitations, the subject matter can decrease bottlenecks and increase data throughput by using a CPU and DPU configuration.

Moreover, DPUs can be optimized for specific data-centric operations, making them easier to program and integrate into workflows as compared to general-purpose CPUs. These efficiencies can also contribute to better scalability, as the DPU can be assigned to specific tasks or computationally or latency-intensive tasks.

Additionally, while a traditional system may achieve similar throughput by adding more cores the system, this can lead to an increase in power consumption and system complexity. The subject matter can achieve higher throughputs while reducing the solution size by offloading to the DPU.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system, comprising:
a server central processing unit (CPU);
a data processing unit (DPU); and
a key-value system (KVS);
wherein the DPU is configured to:
receive, from the server CPU, a communication engine of the KVS;
receive a network packet comprising a key-value request;
transmit the key-value request to the server CPU;
receive a response from the server CPU;
wherein the server CPU is configured to:
transmit the communication engine of the KVS to the DPU;
receive the key-value request from the DPU;
process the key-value request to generate the response; and
transmit the response to the DPU.

2. The system of claim 1, wherein transmitting the key-value request uses a request queue pair shared by the CPU and DPU.

3. The system of claim 1, wherein transmitting the key-value response uses a response queue pair shared by the CPU and DPU.

4. The system of claim 1, wherein the DPU comprises a plurality of DPU cores, wherein the CPU comprises a plurality of CPU cores.

5. The system of claim 1, wherein the communication engine transferred to the DPU is removed from the CPU.

6. The system of claim 4, wherein a core of the plurality of DPU cores is mapped to at most one core of the plurality of CPU cores.

7. The system of claim 4, wherein a core of the plurality of CPU cores is mapped to at most one core of the plurality of DPU cores.

8. The system of claim 4, wherein a core of the plurality of CPU cores is mapped to at least two cores of the plurality of DPU cores.

9. The system of claim 4, wherein a core of the plurality of DPU cores is mapped to at least two cores of the plurality of CPU cores.

10. The system of claim 1, wherein the communication engine transferred to the DPU is not removed from the CPU, wherein the communication engine transferred to the DPU is a first communication engine and the communication engine not removed from the CPU is a second communication engine.

11. The system of claim 1, wherein the communication engine comprises a set of data plane libraries and network interface controller (NIC) drivers.

12. The system of claim 1, wherein the communication engine further comprises:
a function for extracting a key-value request from a network packet;
a response function for allocating and preparing a network buffer, populating the network buffer with a packet comprising a response to the key-value request, and providing the packet to a client device; and
an application programming interface (API) for receiving a network packet from a receive queue.

13. A method, comprising:
transferring a communication engine of a key-value system (KVS) from a server central processing unit (CPU) to a data processing unit (DPU);
receiving, at the DPU, a network packet comprising a key-value request;
parsing, at the DPU, the network packet to extract the key-value request;
transmitting the key-value request from the DPU to the CPU;
processing, at the CPU, the key-value request to generate a response; and
transmitting the response from the CPU to the DPU.

14. The method of claim 13, wherein transmitting the key-value request uses a request queue pair shared by the CPU and DPU.

15. The method of claim 13, wherein transmitting the key-value response uses a response queue pair shared by the CPU and DPU.

16. The method of claim 13, wherein the DPU comprises a plurality of DPU cores, wherein the CPU comprises a plurality of CPU cores.

17. The method of claim 13, wherein the communication engine transferred to the DPU is removed from the CPU.

18. The method of claim 13, wherein the communication engine transferred to the DPU is not removed from the CPU, wherein the communication engine transferred to the DPU is a first communication engine and the communication engine not removed from the CPU is a second communication engine.

19. The method of claim 13, wherein the communication engine comprises a set of data plane libraries and network interface controller (NIC) drivers.

20. The method of claim 13, wherein the communication engine further comprises:
a function for extracting a key-value request from a network packet;
a response function for allocating and preparing a network buffer, populating the network buffer with a packet comprising a response to the key-value request, and providing the packet to a client device; and
an application programming interface (API) for receiving a network packet from a receive queue.
